(19) United States
(12) Patent Application Publication
(10) Pub. No.: US 2010/0215002 A1
(43) Pub. Date: Aug. 26, 2010

(54) METHOD FOR TRANSMITTING SIGNALS, METHOD FOR ALLOCATING RESOURCE AND METHOD FOR CONSTRUCTING UPLINK MAP FOR THE SAME

(75) Inventors: Jeong Ki Kim, Anyang-si (KR); Yong Ho Kim, Anyang-si (KR); Hee Jeong Cho, Anyang-si (KR); Jae Won Lim, Anyang-si (KR); Ki Seon Ryu, Anyang-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/666,758

(22) PCT Filed: Jun. 30, 2008
(86) PCT No.: PCT/KR08/03823

§ 371 Date: Mar. 10, 2010

(30) Foreign Application Priority Data
Jun. 28, 2007 (KR) 10-2007-0064167
Sep. 19, 2007 (KR) 10-2007-0095291

(51) Int. Cl. H04W 72/04

(52) U.S. Cl. 370/329

(57) ABSTRACT

A method for a Base station (BS) to allocate resources to terminals in a broadband wireless access system, a method for transmitting signals of a terminal, and a method for constructing an uplink MAP for the same are provided. Start position information of each allocated region may be included in uplink resource allocation information or information indicating the position of a region dedicated to VoIP traffic may be included in an uplink MAP. The uplink MAP may include separate resource allocation information for VoIP services. Through this resource allocation, the terminal can efficiently transmit uplink signals (specifically, VoIP signals).

### TECHNICAL FIELD

Reference will be made to a method for a Base Station (BS) allocating resources to terminals in a broadband wireless access system, a method for transmitting signals of a terminal, and a method for constructing an uplink MAP for the same. Particularly, reference will be made to a method for a BS efficiently allocating uplink resources to terminals in a broadband wireless access system for signal transmission of the terminals which use Voice-over-Internet-Protocol (VoIP) services, a method for transmitting signals through the same, and a method for constructing a MAP for the same.

### BACKGROUND ART

VoIP traffic is characterized in that VoIP traffic having a fixed size and a fixed period is generated through VoIP codec. VoIP communication can be divided into a communication period (talk-spurt) during which communication is being performed between users and a silence period during which users are listening without speaking. This silence period occupies 50 percent or more of a general call session.

Accordingly, various codecs are used to allocate different bandwidths to the talk spurt and the silence period. An exemplary codec is an Adaptive Multi-Rate (AMR) technique that is used in Global Systems for Mobile Communication (GSM) and Universal Mobile Telecommunications Systems (UMTS).

If a bandwidth is allocated to the silence period, resources will be wasted since no voice data is generated in the silence period. To prevent this, VoIP supports a silence suppression technique. According to the silence suppression technique, a vocoder that generates VoIP traffic does not generate traffic during the silence period and instead generates comfort noise at regular intervals in order to inform the counterpart user that a corresponding call will be maintained. For example, the vocoder that uses the AMR codec generates a fixed-size packet every 20 ms in the talk-spurt and generates comfort noise every 160 ms in the silence period.

On the other hand, a broadband wireless access system (IEEE 802.16e) provides a new scheduling method, which is referred to as an Extended real-time Polling Service (Extended rtPS), for VoIP traffic that supports silence suppression. According to this method, a base station allocates an uplink (UL) bandwidth used for bandwidth request or data transmission to a terminal at regular intervals and does not change the size of the UL allocation until it receives a bandwidth change request from the terminal. When a terminal has issued a bandwidth change request, the base station allocates only a bandwidth (unicast bandwidth request (BR) opportunity) required to transmit a bandwidth request (BR) header or does not allocate any bandwidth if the size of the bandwidth request has been set to zero.

In the current broadband wireless access system (IEEE 802.16e), no separate resource allocation information is transmitted to transmit uplink resource allocation information for the VoIP packet transmission described above to each terminal and MAP information is transmitted by being included in each frame in order to inform each terminal of a resource allocated region allocated to the terminal, similar to general uplink data transmission of the terminal.

For a more detailed description of this method, a frame structure used in the broadband wireless access system is briefly described below.

FIG. 1 illustrates a frame structure used in the broadband wireless access system.

Generally, a frame is a data sequence channel present during a predetermined time period in terms of physical characteristics and includes a downlink (DL) subframe and an uplink (UL) subframe. A frame (IEEE 802.16e) used in the broadband wireless access system includes a preamble 101, an FCH 102, a DL-MAP 103, an UL-MAP 104, and DL/UL bursts 105a and 105b.

Specifically, the preamble 101 is specific sequence data located at a first symbol of each frame and is used for channel estimation or synchronization of a Mobile Station (MS) with a Base Station (BS). The FCH 102 is used to provide channel allocation information and channel code information associated with the DL-MAP 103. The DL-MAP 103 and UL-MAP 104 are MAC messages for notifying an MS of channel resource allocation in uplink/downlink. The DL/UL bursts 105a and 105b are units of data transmitted to or received from an MS. Notification of the size and position of each of the bursts 105a and 105b can be performed through the DL/UL-MAP messages 103 and 104.

DCD and UCD messages are MAC management messages including UL/DL channel parameters of the BS and can be transmitted from the BS to MSs at regular intervals.

On the other hand, the BS can notify terminals (or MSs) of resource regions allocated to the terminals using the DL-MAP and UL-MAP in the frame.

When the BS notifies terminals of DL regions allocated to the terminals using a DL-MAP, the BS can notify the terminals of the allocated regions on a block-by-block basis using an OFDMA symbol offset, a subchannel offset, the number of OFDMA symbols, and the number of subchannels. The BS can use duration information when the BS notifies terminals of UL resource regions allocated to the terminals using a UL-MAP. This method is described below in more detail with reference to Table 1.

The following Table 1 illustrates an example UL-MAP

Information Element (IE) representing UL burst allocation information of a resource allocation information message (MAP) that a BS uses to notify each terminal of a data burst that the BS has allocated to the terminal.

TABLE 1

| Syntax | Size | Note |
|---|---|---|
| UL-MAP_IE( ) { | — | — |
| CID | 16 bits | — |
| UIUC | 4 bits | — |
| if (UIUC == 11) { | | |
| Extended UIUC 2 dependent IE | Variable | See Section 8.4.5.4.4.2 |
| } | | |
| elseif (UIUC == 12) { | — | — |
| OFDMA symbol offset | 8 bits | — |
| Subchannel offset | 7 bits | — |
| No. OFDMA symbols | 7 bits | — |
| No. subchannels | 7 bits | — |
| Ranging method | 2 bits | 0b00 - Initial ranging/Handover |
| | | ranging over two symbols |
| | | 0b01 - Initial ranging/Handover |
| | | ranging over four symbols |
| | | 0b10 - BW request/Periodic Ranging |
| | | over one symbol |
| | | 0b11 - BW Request/Periodic Ranging |
| | | over three symbols |
| Dedicated ranging indicator | 1 bit | 0: OFDMA region and ranging method |
| | | defined are used for normal ranging |
| | | purposes. |
| | | 1: OFDMA region and ranging method |
| | | defined are used for ranging purposes |
| | | using transmission opportunity and |
| | | dedicated CDMA code assigned in a |
| | | MOB-PAG-ADV message or |
| | | MOB_SCN_RSP message. |
| } else if (UIUC == 13) { | — | — |
| PAPR_Reduction_and_Safety_Zone_{—} | 32 bits | — |
| Sounding_Zone_Allocation_IE | | |
| } else if (UIUC == 14) { | — | — |
| CDMA_Allocation_IE( ) | 32 bits | — |
| | 40 bits | |
| } else if (UIUC == 15) { | — | — |
| Extended UIUC dependent IE | Variable | See clauses subsequent to section |
| | | 8.4.5.4.3 |
| } else if (UIUC == 0) { | — | — |
| FAST-FEEDBACK_Allocation_IE( ) | 32 bits | — |
| } else { | — | — |
| Duration | 10 bits | In OFDMA slots (see section 8.4.3.1) |
| Repetition coding indication | 2 bits | 0b00 - No repetition code is used. |
| | | 0b01 - Repetition code 2 is used. |
| | | 0b10 - Repetition code 4 is used. |
| | | 0b11 - Repetition code 6 is used. |
| if (AAS or AMC UL Zone) { | — | Allocate AAS/AMC including absolute |
| | | slot offset |
| Slot offset | 12 bits | Specify an offset in units of slots from |
| | | the start of AAS or AMC zone for this |
| | | allocation. |
| } | — | — |
| } | — | — |
| } | — | — |

A reference symbol such as “8.4.5.4.4.2” in Table 1 denotes an index of an IEEE 802.16e-related standard document.

A method in which a BS allocates UL resources in an IEEE 802.16e-based system is described below with reference to Table 1.

The OFDMA UL-MAP IE illustrated in Table 1 defines uplink bandwidth allocation. In the IEEE 802.16e-based system, uplink bandwidth allocation methods can be divided into a block allocation method using an absolute offset and a duration allocation method using an absolute or relative offset and a duration (in units of slots).

The block allocation method can be used in allocation for fast feedback specified by “UIUC=0”, allocation for CDMA ranging and BW request specified by “UIUC=12”, PAPR/safety zone allocation specified by “UIUC=13”, etc.

On the other hand, an allocation method using duration, which will be referred to as a “duration method”, can be used for all other UL bandwidth allocation including bandwidth allocation for VoIP packet transmission. In the duration method, the start position of allocated resources can be determined taking into consideration previously allocated resource regions in a UL-MAP (see the IEEE 802.16e standard).

In the current broadband wireless access system (IEEE 802.16e), MAP information regarding a allocated resource region allocated to each terminal is transmitted by being included in each frame in order to inform each terminal of the allocated resource region allocated to the terminal, regardless of whether or not data to be transmitted by each terminal is a VoIP packet.

However, since VoIP traffic having a fixed size and a fixed period is generated through the VoIP codec as described above, there is no need to transmit MAP information for VoIP traffic by including the MAP information in each frame as in the resource allocation method provided by the current broadband system.

In addition, since bandwidth allocation for VoIP packet transmission is performed according to the duration method as described above, overhead may occur in processing that a terminal performs for acquiring information of a resource region allocated to the terminal.

### DISCLOSURE

### Technical Problem

An object of the present invention devised to solve the problem lies in providing a method for efficiently allocating UL resources for VoIP traffic and a method for constructing a MAP for the same.

### Technical Solution

In an embodiment of the present invention, the object of the present invention is achieved by providing A method for transmitting signals, the method including reading first uplink MAP information including resource allocation information and transmission period information and performing first transmission through an allocated resource region according to the resource allocation information; and performing second transmission once or more through the allocated resource region of the first transmission in periods according to the transmission period information, wherein the resource allocation information includes start position information of the allocated resource region.

This method takes into consideration mainly the case where a signal transmitted in the first and second transmission is a Voice-over-Internet-Protocol (VoIP) signal.

In another embodiment of the present invention, provided herein is a method for transmitting signals, the method including reading first uplink MAP information including resource allocation information and transmission period information and performing first transmission through an allocated resource region according to the resource allocation information; and performing second transmission once or more through the allocated resource region of the first transmission in periods according to the transmission period information, wherein the first uplink MAP information includes position information of a resource region that has been previously allocated for Voice-over-Internet-Protocol (VoIP) signal transmission.

Here, the method may further include stopping the second transmission, when a second uplink MAP including information different from at least one of the resource allocation information and the transmission period information of the first uplink MAP is received, and performing third transmission according to the information of the second uplink MAP and may further include stopping the second transmission when a third uplink MAP for allocating the allocated resource region of the first transmission to different signal transmission is received in a period according to the transmission period information.

In addition, the first uplink MAP may include separate resource allocation information for the VoIP signal transmission. In this case, the method may further include reading the first uplink MAP to determine information which the first uplink MAP includes from among initial allocation information of uplink resources for the VoIP signal transmission, parameter change information for uplink resource allocation for the VoIP signal transmission, and deallocation information of uplink resources that have been previously allocated for the VoIP signal transmission.

In another embodiment of the present invention, provided herein is a method for allocating resources, the method including allocating a predetermined resource region for first transmission of a terminal and transmitting uplink MAP information including transmission period information and allocation information of the resource region; and allocating the resource region, which was allocated for the first transmission in periods according to the transmission period information, for performing second transmission of the terminal once or more, wherein the allocation information of the resource region includes start position information of the resource region.

In another embodiment of the present invention, provided herein is a method for allocating resources, the method including allocating a predetermined resource region for first transmission of a terminal and transmitting uplink MAP information including transmission period information and allocation information of the resource region; and allocating the resource region, which was allocated for the first transmission in periods according to the transmission period information, for performing second transmission of the terminal once or more, wherein the uplink MAP information further includes position information of a resource region that has been previously allocated for Voice-over-Internet-Protocol (VoIP) signal transmission.

In another embodiment of the present invention, provided herein is a method for constructing an uplink MAP including uplink resource allocation information and transmission period information, wherein the uplink resource allocation information in the uplink MAP includes start position information of a resource region allocated for uplink signal transmission of each terminal.

In another embodiment of the present invention, provided herein is a method for constructing an uplink MAP including uplink resource allocation information and transmission period information, wherein the uplink resource allocation information in the uplink MAP includes position information of a resource region previously allocated for Voice-over-Internet-Protocol (VoIP) signal transmission.

In another embodiment of the present invention, provided herein is a method for constructing an uplink MAP including uplink resource allocation information and transmission period information, wherein the uplink MAP includes separate resource allocation information for Voice-over-Internet-Protocol (VoIP) signal transmission.

In another embodiment of the present invention, provided herein is a method for transmitting signals, the method including reading first control information including resource allocation information and transmission period information and performing first transmission through an allocated resource region according to the resource allocation information; and performing second transmission once or more through the allocated resource region of the first transmission in periods according to the transmission period information, wherein the resource allocation information includes start position information of the allocated resource region.

Here, the method may further include stopping the second transmission, when second control information including information different from at least one of the resource allocation information and the transmission period information of the first control information is received, and performing third transmission according to the information of the second control information.

In addition, the first control information and the second control information may be transmitted through an uplink MAP or a MAC management message and, when the first control information and the second control information are transmitted through the MAC management message, the first control information and the second control information may be transmitted through a service creation (DSA) message, a service change (DSC) message, a service deletion (DSD) message, or a newly defined MAC management message among MAC management messages according to control information included in each of the first control information and the second control information.

### ADVANTAGEOUS EFFECTS

According to the embodiments of the present invention described above, it is possible to reduce both MAP overhead for notification of a resource allocated region of VoIP traffic and processing overhead of terminals.

### DESCRIPTION OF DRAWINGS

FIG. 1 illustrates a frame structure used in a broadband wireless access system.

FIGS. 2 and 3 illustrate examples of a method in which a BS allocates resources to a terminal to provide a VoIP service at regular intervals according to an embodiment of the present invention.

FIG. 4 illustrates a problem that may occur when UL resources are allocated for VoIP packet transmission according to the duration method.

FIG. 5 illustrates a frame structure in the case where a region for resource allocation for VoIP connection of a terminal is preset and used according to another embodiment of the present invention.

FIG. 6 illustrates an embodiment wherein a BS allocates resources for VoIP to a terminal in advance using service creation messages (DSA-REQ/RSP messages) in the case where the terminal has requested that a service be created.

FIG. 7 illustrates another embodiment wherein a BS allocates resources for VoIP to a terminal in advance using service creation messages (DSA-REQ/RSP messages) in the case where the BS has requested that a service be created.

FIG. 8 illustrates another embodiment wherein a BS changes an allocated resource region using service creation messages (DSC-REQ/RSP messages).

FIG. 9 illustrates an embodiment wherein a BS deletes a resource region allocated to a terminal using service creation messages (DSD-REQ/RSP messages) in the case where the terminal has requested that a service be deleted.

FIG. 10 illustrates another embodiment wherein a BS deletes a resource region allocated to a terminal using service creation messages (DSD-REQ/RSP messages) in the case where the BS has requested that a service be deleted.

FIG. 11 illustrates another embodiment wherein a BS deletes a resource region allocated to a terminal using service creation messages (DSD-REQ/RSP messages) in the case where only the allocated resource region is deleted.

FIG. 12 illustrates an embodiment wherein resources for VoIP are allocated in advance using a MAC management message suggested in the present invention.

FIG. 13 illustrates an embodiment wherein allocated resources are changed using a MAC management message suggested in the present invention.

FIG. 14 illustrates an embodiment wherein allocated resources are deleted using a MAC management message suggested in the present invention.

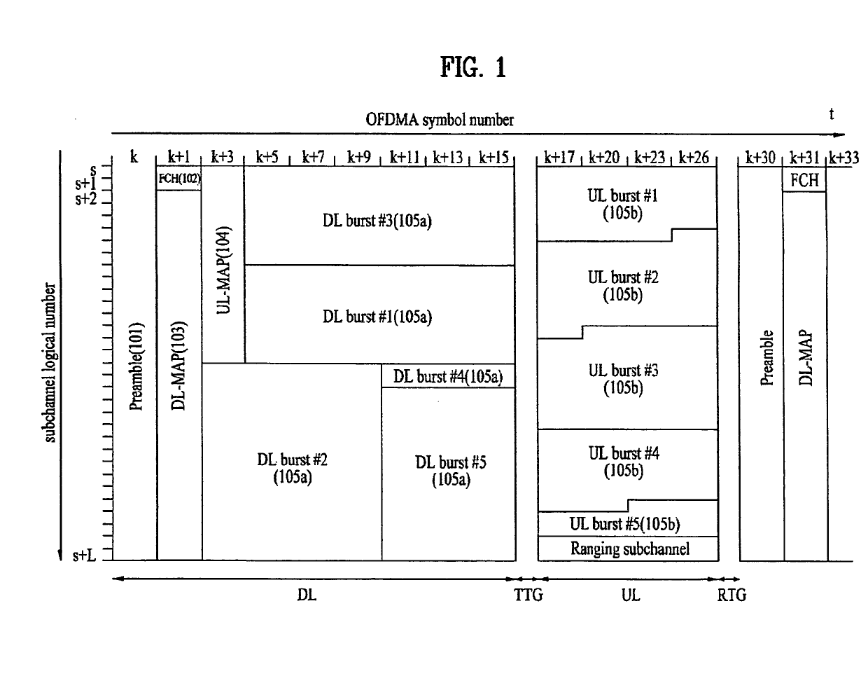

### MODE FOR INVENTION

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

In an embodiment of the present invention, a Base Station (BS) can use a method of fixedly allocating a dedicated (or specified) region to a specific terminal or Mobile Station (MS) in order to allocate resources to traffic such as VoIP traffic that has a fixed size and a predetermined period. That is, the BS can allocate a fixed-size region to a terminal, which supports VoIP services, at an initial stage and can notify the terminal of information of the allocated region through an initially transmitted UL-MAP. Period information of subsequently allocated regions may also be included in the initially transmitted UL-MAP.

Thereafter, in subsequent periods, the BS can persistently allocate the corresponding region to the terminal without special notification of the region, of which the terminal was notified through the UL-MAP at an initial stage. Accordingly, the terminal transmits VoIP packets through a region allocated using information of a region that was allocated in a MAP at an initial stage and transmits VoIP packets through the same region in subsequent periods determined using the period information.

On the other hand, when a UL-MAP message transmitted thereafter includes allocation information of a region that overlaps the region that was allocated for VoIP at an initial stage, the terminal does not transmit VoIP packets through the initially allocated region. If the terminal already has allocation information for VoIP connection when a UL-MAP IE corresponding to the terminal for VoIP allocation is received or when a UL-MAP IE for position change of VoIP allocation is received, the terminal transmits VoIP packets through a newly allocated region instead of the previously allocated region.

These embodiments will now be described in more detail with reference to the drawings.

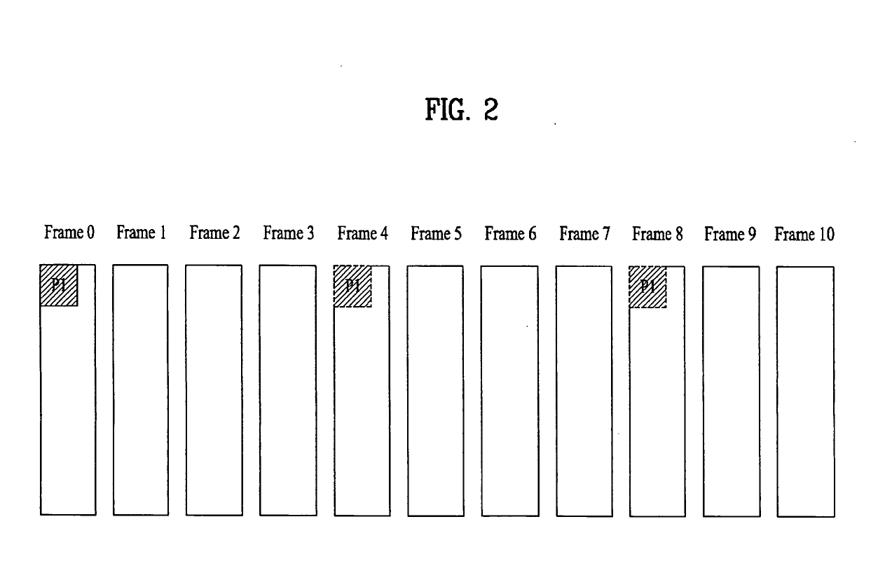

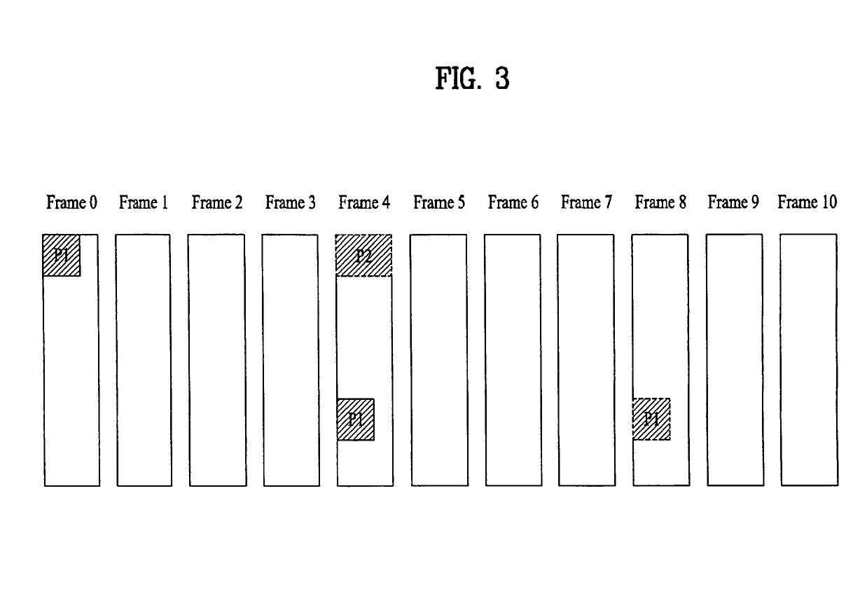

FIGS. 2 and 3 illustrate examples of a method in which a BS allocates resources to a terminal to provide a VoIP service at regular intervals according to an embodiment of the present invention.

Specifically, FIG. 2 illustrates an example wherein a frame length is set to 5 ms taking into consideration the VoIP service and a frame period allocated for a terminal for VoIP packet transmission is set to 4 frames. Here, the frame period allocated for a terminal for VoIP packet transmission may vary depending on the characteristics of the service. Even in the case of the same VoIP service, the frame period allocated for a terminal for VoIP packet transmission may be defined to be different taking into consideration factors such as system characteristics (for example, system characteristics according to the frame length) and the state of the VoIP service (for example, the talk-spurt or silence period).

In the example of FIG. 2, the BS notifies the terminal of allocated region information for VoIP packet transmission through a UL-MAP in Frame 0, which is the first frame, and thereafter allocates only the region for VoIP packet transmission without notifying the terminal of the region information through a UL-MAP in Frame 4 and Frame 8 which are first frames of subsequent periods.

Here, a period allocated for VoIP packet transmission is four frames (i.e., 20 ms). That is, the terminal stores the region allocation information included in the UL-MAP received in Frame 0 so that the terminal can transmit a VoIP packet through the corresponding region in Frames 4 and 8 even though no UL-MAP is received.

The following is a description of the example of FIG. 3.

In the example of FIG. 3, the BS can allocate a region P1 for VoIP packet transmission of a specific terminal in Frame 0 and can transmit information of the allocated region through a UL-MAP.

Thereafter, in Frame 4, the BS allocates a resource P2 for other terminals to the region P1 that was allocated for VoIP in Frame 0 and allocates a resource for the terminal, which transmitted a VoIP packet in Frame 0, to a different region. Accordingly, in Frame 4, the terminal that transmitted a VoIP packet in Frame 0 can confirm that a resource has been allocated to a region different from the initially allocated region and can transmit a VoIP packet through the newly allocated region (P1 in Frame 4), instead of transmitting a VoIP packet through the initially allocated region (P2 in Frame 4), and then can update relevant parameters.

Alternatively, when new resource allocation has been performed for the region P1 in Frame 4, the terminal may determine that the previously allocated region has been allocated for other packet transmission and thus may not transmit a VoIP packet through the previously allocated region.

Using the resource allocation method described above, it is possible to reduce overhead caused by the transmission of UL resource allocation information to a terminal that supports VoIP services in each frame.

However, if the BS notifies a terminal of the information of a region allocated to the terminal through a UL-MAP only in the first frame for VoIP allocation and does not notify the terminal of the allocated region information in frames of subsequent periods according to the embodiment described above, when the duration method is used as a method for notifying the terminal of UL region information for VoIP packet transmission using the current broadband wireless access system (IEEE 802.16e), other terminals may erroneously transmit their packets through regions other than those allocated to the terminals since the information of the region allocated for VoIP packet transmission of the terminal is omitted.

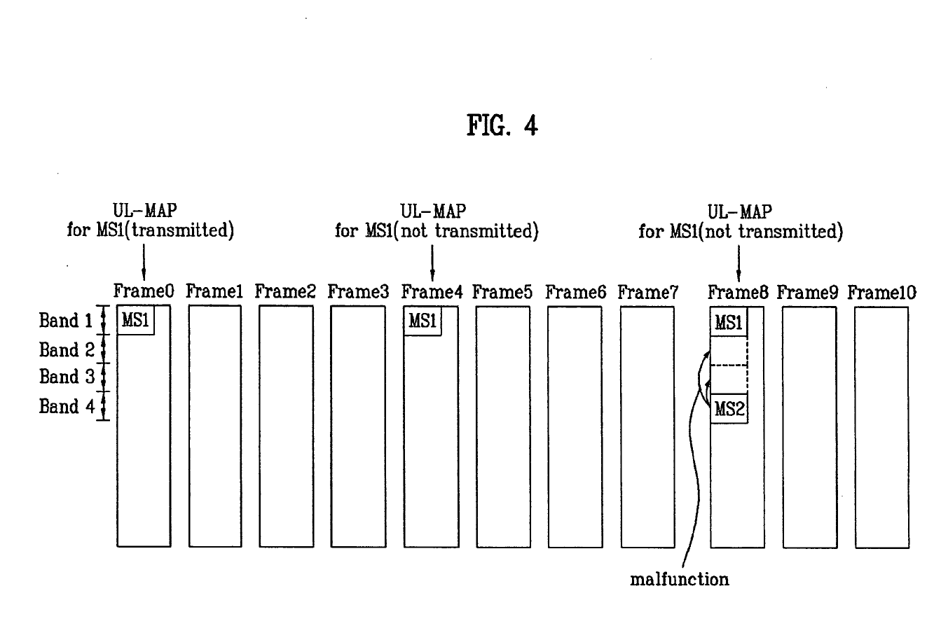

This problem is described below in more detail with reference to FIG. 4.

FIG. 4 illustrates a problem that may occur when UL resources are allocated for VoIP packet transmission according to the duration method.

In FIG. 4, an MS1 can be allocated a band 1 for VoIP packet transmission in a first frame (Frame 0) and can receive information of the allocated bandwidth through a UL-MAP as described above with reference to FIGS. 2 and 3. However, when the band allocated to the MS1 is not changed in Frame 4 and Frame 8, which are first frames of subsequent transmission periods, the information of the band allocated to the MS1 may not be provided to the MS1 through a UL-MAP in Frame 4 and Frame 8.

On the other hand, beginning with Frame 8, an MS2 can be allocated a UL resource by the BS for specific UL signal transmission. Here, when the MS2 determines a band allocated to the MS2 according to the conventional method of the broadband wireless access system (i.e., according to the duration method) after receiving a UL-MAP for initially allocating a band 4 to the MS2 from the BS, the MS2 may transmit its signal through a band 2 or a band 3 rather than the band 4 as shown in FIG. 4 since the information of allocation of the band 1 to the MS1 is omitted in the previous frames. Specifically, the MS2 may erroneously transmit its signal through the band 3 rather than the band 4 since the information of allocation of the band 1 to the MS1 is omitted in Frame 4 and may erroneously transmit its signal through the band 2 rather than the band 4 since the information of allocation of the band 1 to the MS1 is omitted in Frame 4 and the information of allocation of the band 1 is omitted in Frame 8 (in the case where it is necessary to give priority to calculation of the allocation information of the band 1 in Frame 8). That is, the MS2 may erroneously determine the start position of a resource region allocated to the MS2 due to the omission of the resource allocation information of the MS1 since the start position of an allocated resource region is determined taking into consideration a previously allocated resource region in a UL-MAP when the duration method is used as a method for allocating UL resources as described above.

Accordingly, a preferred embodiment of the present invention aims to suggest the following method for generating a MAP for UL resource allocation and to provide a method for efficiently allocating resources for VoIP packet transmission using the method.

Table 2 illustrates an example UL-MAP IE suggested according to a preferred embodiment of the present invention in order to allow a BS to persistently allocate a specific VoIP region to each terminal.

TABLE 2

| Syntax | Size | Note |
|---|---|---|
| UL-MAP_IE( ) { | — | — |
| CID | 16 bits | — |
| UIUC | 4 bits | — |
| OFDMA symbol offset | 8 bits | — |
| Subchannel offset | 8 bits | — |
| Duration | 10 bits | In units of OFDMA slots |
| | | (see section 8.4.3.1) |
| Repetition coding | 2 bits | 0b00 - No repetition code is used. |
| indication | | 0b01 - Repetition code 2 is used. |
| | | 0b10 - Repetition code 4 is used. |
| | | 0b11 - Repetition code 6 is used. |
| } | — | — |

Similar to Table 1, a reference symbol such as “8.4.3.1” in Table 2 denotes an index of an IEEE 802.16e-related standard document. Table 2 illustrates only a part of Table 1 specified in cases other than UIUCs 0 and 11-15.

When only the conventional duration information is used to notify terminals of UL resource regions allocated to the terminals, it is necessary that the terminals search for all UL-MAP IEs of previous frames and then perform calculations in order to determine the regions allocated to the terminals. In addition, when the method for allocating a specified (or dedicated) region to a VoIP terminal at regular intervals is applied, terminals cannot correctly locate their regions with only the duration information in a frame including no UL-MAP information since allocated region information is provided to the terminals through a UL-MAP only in the first frame. This problem has been described above with reference to FIG. 4.

Accordingly, in a preferred embodiment of the present invention, the above problem can be overcome by additionally carrying information of an OFDMA symbol offset and a subchannel offset in a UL-MAP IE as in Table 2 when notifying terminals of information of regions allocated to the terminals.

In the following, reference is made to a method that be used when performing initial can allocation/change/deallocation of UL resources for VoIP packet transmission to a terminal in the method for allocating resources for VoIP packet transmission to a terminal according to the above embodiment of the present invention.

The following Table 3 illustrates an example extended UIUC code that can be used when a BS allocates UL VoIP resources to a terminal in an embodiment of the present invention.

TABLE 3

| Extended | |
|---|---|
| UIUC | |
| (hexadecimal) | Usage |
| 00 | Power_control_IE |
| 01 | Mini-subchannel_allocation_IE reserved |
| 02 | AAS_UL_IE |
| 03 | CQICH_Alloc_IE |
| 04 | UL Zone IE |
| 05 | PHYMOD_UL_IE |
| 06 | VoIP_UL_IE |
| 07 | UL-MAP_Fast_Tracking_IE |
| 08 | UL_PUSC_Burst_Allocation_in_Other_Segment_IE |
| 09 | Fast_Ranging_IE |
| 0A | UL Allocation Start IE |
| 0B-0F | Reserved |

That is, Table 3 shows an example extended UIUC 06 defined for VoIP allocation. However, a VoIP_UL_IE for VoIP allocation may also be defined in an extended UIUC of 0B to 0F denoted by “Reserved” in Table 3. Although an extended UIUC is specified for defining a VoIP_UL_IE in this example, the VoIP_UL_IE may also be allocated in a basic UIUC or an extended UIUC 2.

When the extended UIUC indicates “06” in the case where the extended UIUC is defined as in Table 3, the terminal can determine that the terminal has been allocated a region for VoIP packet transmission by the BS, specifically, that the region for VoIP packet transmission has been initially allocated/changed/deallocated by the BS.

Table 4 illustrates an example VoIP_UL_IE that is specified by the extended UIUC as described above.

TABLE 4

| Syntax | Size | Note |
|---|---|---|
| VoIP_UL_IE( ) { | — | — |
| Extended UIUC | 4 bits | VoIP_UL = 0x06 |
| Length | 4 bits | Variable |
| type | 2 bits | 0b00 = Initial allocation |
| | | 0b01 = Parameter change |
| | | 0b10 = deallocation |
| | | 0b11 = reserved |
| If (type == 0b00) { | — | — |
| UIUC | 4 bits | UIUC for transmission |
| OFDMA symbol offset | 8 bits | — |
| Subchannel offset | 8 bits | — |
| Duration | 4 bits | In units of OFDMA slots |
| Period(P) | 4 bits | BS allocates resources using duration and |
| | | offsets included in IE every 2^{P} frame. |
| Repetition coding indication | 2 bits | 0b00 - No repetition code is used. |
| | | 0b01 - Repetition code 2 is used. |
| | | 0b10 - Repetition code 4 is used. |
| | | 0b11 - Repetition code 6 is used. |
| } else if (type == 0b01) { | — | — |
| Change type | 2 bits | 0b00 - Only slot offset is changed. |
| | | 0b01 - Only duration is changed. |
| | | 0b10 - Frame offset is changed. |
| | | 0b11 - Duration, period, and repetition code are |
| | | changed. |
| If ( change type == 0b00) { | — | — |
| OFDMA symbol offset | 8 bits | |
| Subchannel offset | 8 bits | |
| } else if ( change type == | — | — |
| 0b01) { | | |
| UIUC | 4 bits | UIUC for transmission |
| Duration | 4 bits | In units of OFDMA slots |
| Repetition coding indication | 2 bits | 0b00 - No repetition code is used. |
| | | 0b01 - Repetition code 2 is used. |
| | | 0b10 - Repetition code 4 is used. |
| | | 0b11 - Repetition code 6 is used. |
| } else if (change type == 0b10) | — | — |
| { | | |
| UIUC | 4 bits | UIUC for transmission |
| Frame offset (S) | 6 bits | BS will continue allocation S frames after the |
| | | current frame. |
| OFDMA symbol offset | 8 bits | — |
| Subchannel offset | 8 bits | — |
| Duration | 4 bits | In units of OFDMA slots |
| Repetition coding indication | 2 bits | 0b00 - No repetition code is used. |
| | | 0b01 - Repetition code 2 is used. |
| | | 0b10 - Repetition code 4 is used. |
| | | 0b11 - Repetition code 6 is used. |
| Mode Indication | 1 bit | 0b0 - Resource allocation is maintained in |
| | | current frame. |
| | | 0b1 - Resource allocation is released in current |
| | | frame. |
| } else { | — | — |
| UIUC | 4 bits | UIUC for transmission |
| Duration | 4 bits | In units of OFDMA slots |
| Period | 4 bits | |
| Repetition coding indication | 2 bits | 0b00 - No repetition code is used. |
| | | 0b01 - Repetition code 2 is used. |
| | | 0b10 - Repetition code 4 is used. |
| | | 0b11 - Repetition code 6 is used. |
| } | — | — |
| } else if (type == 0b10) { | — | — |
| | — | — |
| } | — | — |
| Padding | Variable | The number of bits for matching to the byte |
| | | length. |
| | | This can be set to 0. |
| } | — | — |

The VoIP_UL_IE as shown in Table 4 may be included in a UL-MAP IE when the BS initially allocates/changes/deallocates UL resources for VoIP packet transmission of a terminal as described above. The BS can appropriately allocate resources to a terminal using an OFDMA symbol offset, a subchannel offset, duration and period information, etc.

Reference will now be made in detail to a method for allocating UL resources for VoIP packet transmission using the above Table 4 for each of a variety of cases.

First, reference is made to the method when the result of receiving and reading the VoIP_UL_IE is that the type field indicates “0b00”.

When the type field indicates “0b00”, the terminal determines that the VoIP_UL_IE is a message for initially allocating resources for VoIP transmission and stores relevant parameters of an OFDMA symbol offset, a subchannel offset, a duration, a period, and a repetition coding indicator written in fields subsequent to “if (type==0b00)” of Table 4, and transmits a VoIP packet through a region allocated to the terminal using information such as the OFDMA symbol offset, the subchannel offset, and the duration. Thereafter, the terminal can transmit a VoIP packet through a region at the same position as the initially allocated region in frames in subsequent periods according to the period information P. Specifically, Table shows that the BS allocates resources to the corresponding terminal using offsets and duration information included in the VoIP_UL_IE every 2^{P} frame.

When the type of the VoIP_UL_IE received by the terminal is “0b00” in the case where the terminal has information of resources previously allocated for VoIP connection, the previous allocation information is changed to a new value and the terminal can transmit a VoIP packet using parameters according to the new received VoIP_UL_IE. In addition, the BS can set the type of the VoIP_UL_IE to “0b00” when the BS desires to change the position and size of a region to be allocated for a variety of reasons such as channel changes.

Next, reference is made to the method when the result of receiving and reading the VoIP_UL_IE is that the type field indicates “0b01”.

When the type is “0b01”, the terminal determines that the received VoIP_UL_IE is a message regarding parameter changes and reads a change type flag. While the BS can transmit information with the type of the VoIP_UL_IE being set to “0b00” when the BS desires to change the position, size, etc., of the region to be allocated as described above, the BS can set the type to “0b01” when the BS desires to selectively change specific parameters as described below.

When the BS desires to change only the position of the region for resource allocation for a variety of reasons such as channel changes, the BS can set the change type to “0b00”. When the change type is “0b00”, the terminal can change the current position (start position) using information such as the OFDMA symbol offset and the subchannel offset as shown in fields subsequent to “else if (type==0b01)” of Table 4 and then can transmit a VoIP packet using the changed position and using remaining parameters without change.

In addition, when the terminal has requested that the size of the region for allocation be changed since the size of the VoIP packet was changed or when the BS changed the size of the region for allocation since the channel state was changed, the BS sets the change type to “0b01”. When the change type is “0b01”, the terminal updates duration information and repetition coding indicator information and transmits a VoIP packet through a region specified using the changed parameters.

The terminal which transmits a fixed-size VoIP packet can determine how much the BS can allocate resources by checking a UIUC in a field corresponding to the change type “0b01” in Table 4. When the UIUC has been changed due to a channel change (or modulation and coding rate change), the BS transmits a VoIP_UL_IE including only the UIUC information. When the terminal receives a VoIP_UL_IE including only the UIUC information, the terminal calculates an appropriate duration using the received UIUC.

On the other hand, when a delay longer than a predetermined time has occurred between the time when the mobile terminal generates a VoIP packet and the time when the BS performs resource allocation, the mobile terminal may request, through a frame delay field of a (resource allocation) grant management subheader, that the BS change the time of the periodic resource allocation for VoIP packet transmission. If the BS determines that it is necessary to change the resource allocation time for such a reason, the BS sets the change type to “0b10” and may incorporate a frame offset (S) at which new allocation starts, the allocation position in a frame at which allocation starts (such as an OFDMA symbol offset and a subchannel offset), and size information (such as duration and repetition coding indicator) into the VoIP_UL_IE as shown in fields indicated by “else if (change type==0b10)” in Table 4.

In addition, the BS may also incorporate information as to whether the previously allocated region is maintained in the current frame as a “mode indication” into the VoIP_UL_IE. When the mode indication is “0b0” as shown in Table 4, the terminal determines that, in the current frame and in a frame S frames later, resources have been allocated to the same region as the previously (or initially) allocated region and transmits a VoIP packet through the same position of the current frame and updates relevant parameters with parameters included in the When the mode indication is “0b1”, the terminal determines that previously allocated resources have been deallocated in the current frame and does not transmit a VoIP packet and updates relevant parameters with parameters included in the VoIP_UL_IE.

On the other hand, when the VoIP state is changed from a talk state to a silence state or from a silence state to a talk state, the size and period of the VoIP packet can be changed. In this case, the BS can set the change type to “0b11” and can notify the terminal of the change type set to “0b11”. When the change type is “0b11”, this corresponds to the last change type field (i.e., a field subsequent to “else”) among fields of the type of the VoIP_UL_IE “0b01” in Table 4 and the terminal updates the duration, period, and repetition coding indicator information specified in the corresponding field and can transmit a VoIP packet using the changed parameters.

Reference is now made to the last type “0b01” among the VoIP_UL_IE types defined in Table 4.

When the VoIP communication state has been changed from a talk state to a silence state, the BS can deallocate the allocated region and can set the type of the VoIP_UL_IE to “0b10” to notify the terminal of the deallocated region. When the type is “0b10”, the terminal determines that the region previously allocated for VoIP has been deallocated and deletes MAP information associated with VoIP connection.

When the BS performs new allocation for a terminal that has an allocated region dedicated for VoIP connection regardless of time (frame) or slots, the BS can deallocate the previously allocated region and can notify the terminal of the deallocated region. That is, when the terminal receives a VoIP_UL_IE (type==0b00) requesting initialization at an offset of any slot or any frame, the terminal updates previous parameters regarding VoIP connection with the new received parameters. In addition, when a service of VoIP is deleted (after a Dynamic Service Deletion (DSD) process), the BS can transmit a VoIP_UL_IE including a type of “0b10” and accordingly the terminal can delete relevant parameters.

Terminals that maintain VoIP connection may also identify all UL-related MAP information in a frame of a corresponding period. If new allocation is performed to a region allocated to a terminal for VoIP, the terminal does not transmit a VoIP packet through the previously allocated region.

Reference will now be made to a method for allocating resources for VoIP packet transmission and a method for constructing a MAP for the same according to another embodiment of the present invention.

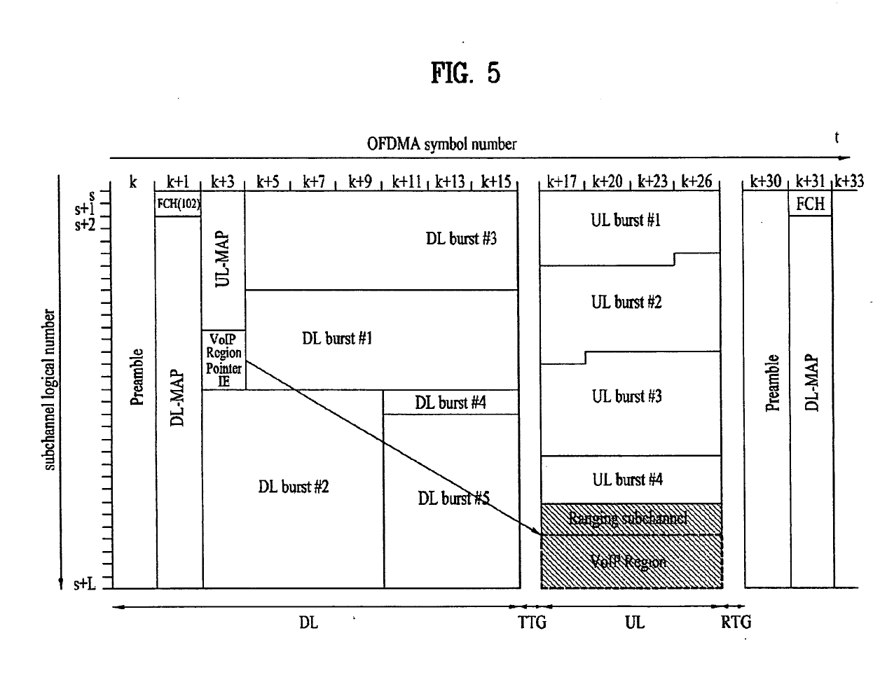

FIG. 5 illustrates a frame structure in the case where a region for resource allocation for VoIP connection of a terminal is preset and used according to another embodiment of the present invention.

Specifically, in the frame structure shown in FIG. 5, a separate region for VoIP packet transmission is set and position information of the region is transmitted through a VoIP region pointer IE in a UL-MAP.

In the case where a BS allocates UL resources to terminals using the frame structure as shown in FIG. 5, it is possible to notify general users of the positions of bursts allocated to the users using the duration method according to the conventional UL-MAP without modifying the conventional UL-MAP structure.

In the following description, it is assumed that a specific region is fixedly allocated to a specific MS for VoIP packet transmission according to the embodiment as shown in FIGS. 2 and 3. For example, the BS may notify an MS1 of the position of a resource region allocated to the MS1 through a UL-MAP only in the first frame in order to allocate a fixed resource region to the MS1 and may not separately notify the MS1 of the resource region in subsequent frames. Here, since general MSs that transmit UL signals other than VoIP packets determine the start positions of resource regions allocated to the MSs, excluding regions dedicated to IP packet transmission as shown in FIG. 5, the MSs can be prevented from incorrectly determining the regions allocated to the MSs even if allocation information for VoIP packet transmission of the MS1 is omitted.

Thus, according to this embodiment which uses the frame structure as shown in FIG. 5, general users can use the conventional UL-MAP structure and resource allocation method without change and users who transmit VoIP packets at intervals of a predetermined period through a fixed resource region can acquire allocated resource region information through a UL-MAP only in the first frame and can transmit VoIP packets through the corresponding region without reading the UL-MAP in subsequent frames as described above with reference to FIGS. 2 and 3.

In order to obtain the frame structure as shown in FIG. 5, it is necessary to provide a pointer IE indicating an allocated region dedicated to VoIP packet transmission in the UL-MAP as shown in FIG. 5. An example of the pointer IE is illustrated in Table 5.

TABLE 5

| Syntax | Size | Note |
|---|---|---|
| VoIP_Region_Pointer_IE( ) { | — | — |
| Extended UIUC | 4 bits | VoIP_UL = 0x06 |
| Length | 4 bits | Variable |
| OFDMA symbol offset | 8 bits | |
| Subchannel offset | 8 bits | |
| Duration | 10 bits | |
| } | | |

On the other hand, when the allocated region dedicated to VoIP packet transmission is located at an end portion of the UL burst region as shown in FIG. 5, it is possible to additionally omit the duration parameter in the VoIP_Region_Pointer of Table 5.

In the case where resources for VoIP packet transmission are allocated according to this embodiment which uses the frame structure as shown in FIG. 5, each MS that performs VoIP packet transmission can be allocated a region within the region dedicated to VoIP packet transmission using a VoIP_Alloc_IE as in an example illustrated in the following Table 6.

TABLE 6

| Syntax | Size | Note |
|---|---|---|
| VoIP_Alloc_IE( ) { | — | — |
| Extended UIUC | 4 bits | |
| Length | 4 bits | Variable |
| UIUC | 4 bits | UIUC for transmission |
| OFDMA symbol | 8 bits | — |
| offset | | |
| Subchannel offset | 8 bits | — |
| Duration | 4 bits | In units of OFDMA slots |
| Repetition coding | 2 bits | 0b00 - No repetition code is used. |
| indication | | 0b01 - Repetition code 2 is used. |
| | | 0b10 - Repetition code 4 is used. |
| | | 0b11 - Repetition code 6 is used. |
| Padding | Variable | The number of bits for matching to |
| | | the byte length. |
| | | This can be set to 0. |
| } | — | — |

On the other hand, after a terminal obtains position information of its resource region at an initial stage using the VoIP_Alloc_IE as shown in Table 6, the terminal can transmit its packets in subsequent frames without receiving the VoIP_Alloc_IE as shown in Table 6 at unsolicited grant intervals defined through negotiation with the BS when a service flow is set.

In addition, when it is necessary to change VoIP allocation of the terminal for reasons such as a scheduling situation of the BS, it is possible to change the frame offset or the like through a VoIP_Control_IE as in an example illustrated in the following Table 7.

TABLE 7

| Syntax | Size | Note |
|---|---|---|
| VoIP_Control_IE( ) { | — | — |
| Extended UIUC | 4 bits | |
| Length | 4 bits | Variable |
| Frame offset | 4 bits | This indicates a frame offset between |
| | | the current frame and a frame for |
| | | allocation such that VoIP packets are |
| | | transmitted through subsequently |
| | | allocated regions after this offset. |
| OFDMA symbol | 8 bits | — |
| offset | | |
| Subchannel offset | 8 bits | — |
| Duration | 4 bits | In units of OFDMA slots |
| Repetition coding | 2 bits | 0b00 - No repetition code is used. |
| indication | | 0b01 - Repetition code 2 is used. |
| | | 0b10 - Repetition code 4 is used. |
| | | 0b11 - Repetition code 6 is used. |
| Padding | Variable | The number of bits for matching to |
| | | the byte length. |
| | | This can be set to 0. |
| } | — | — |

In this embodiment, the mobile terminal checks a UL-MAP in a frame of a period for VoIP packet transmission from the terminal. When a VoIP_Control_IE is present in the UL-MAP, the terminal can detect that a frame for transmission from the terminal is not the current frame and has been changed to a frame specified in the VoIP_Control_IE and then can transmit data in the specified frame. In subsequent operations, the terminal can transmit a VoIP packet at intervals defined through negotiation made when a service flow is set.

On the other hand, the VoIP_Alloc_IE illustrated in Table 6 and the VoIP_Control_IE illustrated in Table 7 can be represented by one VoIP_Alloc_IE as in the following Table 8.

TABLE 8

| Syntax | Size | Note |
|---|---|---|
| VoIP_Alloc_IE( ) { | — | — |
| Extended UIUC | 4 bits | |
| Length | 4 bits | Variable |
| UIUC | 4 bits | UIUC for transmission |
| Control Flag | 1 bits | control |
| If (Control Flag == 1) { | | |
| Frame offset | 4 bits | This indicates a frame offset |
| | | between the current frame and a |
| | | frame for allocation such that |
| | | VoIP packets are transmitted |
| | | through subsequent allocated |
| | | regions after this offset. |
| } | — | — |
| OFDMA symbol | 8 bits | — |
| offset | | |
| Subchannel offset | 8 bits | — |
| Duration | 4 bits | In units of OFDMA slots |
| Repetition coding | 2 bits | 0b00 - No repetition code is used. |
| indication | | 0b01 - Repetition code 2 is used. |
| | | 0b10 - Repetition code 4 is used. |
| | | 0b11 - Repetition code 6 is used. |
| Padding | Variable | The number of bits for matching to |
| | | the byte length. |
| | | This can be set to 0. |
| } | — | — |

That is, in this example, the VoIP_Alloc_IE of Table 8 serves as the VoIP_Control_IE of Table 7 when a control flag is “1” in Table 8 and serves as the VoIP_Alloc_IE of Table 6 in other cases. Similar to the VoIP_UL_IE of Table 4, IEs shown in Tables 7 and 8 can be specified by an extended UIUC as described above with reference to Table 3 and can also be specified by a basic UIUC or extended UIUC2 as described above with reference to Table 3.

The method for allocating regions for VoIP traffic transmission using a VoIP_UL_IE as shown in Table 4 and the method for allocating regions for VoIP traffic transmission using a VoIP_Alloc_IE (or a combination of a VoIP_Alloc_IE and a VoIP_Control_IE) as shown in Table 8 described above in the embodiments of the present invention can be selectively used according to whether or not a region dedicated to VoIP packet transmission as shown in FIG. 5 has been set in a frame.

That is, it is preferable that the method using a VoIP_Alloc_IE (or a combination of a VoIP_Alloc_IE and a VoIP_Control_IE) be selected when a VoIP region pointer IE is present in a UL-MAP in a frame as shown in FIG. 5 and the method using a VoIP_UL_IE be selected when no VoIP region pointer IE is present in a UL-MAP in a frame.

In the methods described above, using a MAP IE, the BS notifies a terminal of information of a resource region, which is to be used for VoIP packet transmission, during-initial VoIP packet transmission. In the following, reference is made to a method in which a BS notifies a terminal of information of a resource region to be used for VoIP packet transmission using a MAC management message (for example, a DSA-REQ/RSP or newly defined MAC management message) when a service is generated.

When a service is generated (or changed or removed), it is necessary that information of a persistent resource allocated region for VoIP be included in a control (or MAC management) message. Tables 9 and 10 are TLVs representing information for persistent VoIP allocation that can be included in a MAC management message (for example, DSx (DSA/DSC/DSD) message) of IEEE 802.16.

TABLE 9

| Name | Type | Length | Value |
|---|---|---|---|
| VoIP_PALLOC_INFO | x | 5 | See Table 10 |

TABLE 10

| Item | Size | Notes |
|---|---|---|
| UIUC | 4 bits | UIUC for transmission |
| OFDMA symbol offset | 8 bits | The number of bandwidth |
| Subchannel offset | 8 bits | This parameter defines the PHY |
| | | specific preamble. |
| Duration | 4 bits | In units of OFDMA slots |
| Repetition coding indication | 2 bits | 0b00 - No repetition code is used. |
| | | 0b01 - Repetition code 2 is used. |
| | | 0b10 - Repetition code 4 is used. |
| | | 0b11 - Repetition code 6 is used. |
| Frame offset | 3 bits | The SS starts reporting at the frame |
| | | of which the number has the same |
| | | 3 LSB as the specified frame |
| | | offset. If the current frame is |
| | | specified, the SS should start |
| | | reporting in eight frames |
| Period(P) | 4 bits | BS allocates resources using |
| | | duration and offsets included in IE |
| | | every 2^{P} frame. |
| Reserved | 7 bits | — |

Specifically, Table 9 represents a VoIP_PALLOC_INFO TLV and Table 10 represents a description of the VoIP_PALLOC_INFO TLV.

Table 11 represents a TLV that is included in a MAC management message (DSx) for resource allocation when a service is generated and indicates whether or not the persistent resource allocation method is applied.

TABLE 11

| Name | Type | Length | Value | Scope |
|---|---|---|---|---|
| Persistent_VoIP_Enabling | x | 1 | 0: No persistent | DSx- |
| | | | resource | REQ, |
| | | | allocation is | DSx-RSP, |
| | | | applied to a | DSx-ACK |
| | | | service (for | |
| | | | example, VoIP) | |
| | | | 1: The | |
| | | | persistent | |
| | | | resource | |
| | | | allocation is | |
| | | | applied to a | |
| | | | service (for | |
| | | | example, VoIP) | |

Specifically, Table 11 may be referred to as a “persistent VoIP enabling TLV” and a VoIP_PALLOC_INFO TLV is included in the DSA-REQ/RSP message when the persistent VoIP enabling TLV is set to “1”.

If a BS and a terminal exchange persistent resource allocation information using the DSA-REQ/RSP message, then the BS persistently allocates resources for uplink/downlink to the terminal using the exchanged information and the terminal performs transmission and reception with the BS using the allocated resources.

When there is a need to change the allocated resource region, it is possible to change the allocated resources by transmitting a DSC message including information that is to be changed (i.e., a VoIP_PALLOC_INFO TLV). In another method, it is possible to change the resource region using UL-MAP IEs (for example, VoIP_UL_IEs or VoIP_Control_IEs) for VoIP allocation described above. If there is a need to change the allocated resource region using a UL-MAP IE, resource allocated region information exchanged when a service is generated may be updated with a new value.

When there is a need to remove the allocated resource region, it is possible to remove the allocated resources by transmitting a DSC message including information that is to be removed. If the DSD message is used for removing the service, it is possible to remove the allocated region connected to the service through only the DSD message without the need to incorporate the resource allocation information into the DSD message. If the DSD message is used for removing the allocated resource region information rather than removing the service, only the allocated resource region can be removed using the DSD message without removing the service.

Table 12 represents a TLV that can be included in a DSD message for removing a persistently allocated region.

TABLE 12

| Name | Type | Length | Value | Scope |
|---|---|---|---|---|
| Allocation_Delete | x | 1 | 0: Remove | DSx-REQ, DSx- |
| Indication TLV | | | current service | RSP, DSx-ACK |
| | | | together with | |
| | | | removal of | |
| | | | allocated | |
| | | | region | |
| | | | 1: Remove | |
| | | | resource | |
| | | | allocated | |
| | | | region while | |
| | | | maintaining | |
| | | | service | |

Specifically, through an “Allocation_Delete_Indication TLV” shown in Table 12, it is possible to indicate whether or not to perform removal of a corresponding service together with control of allocated region.

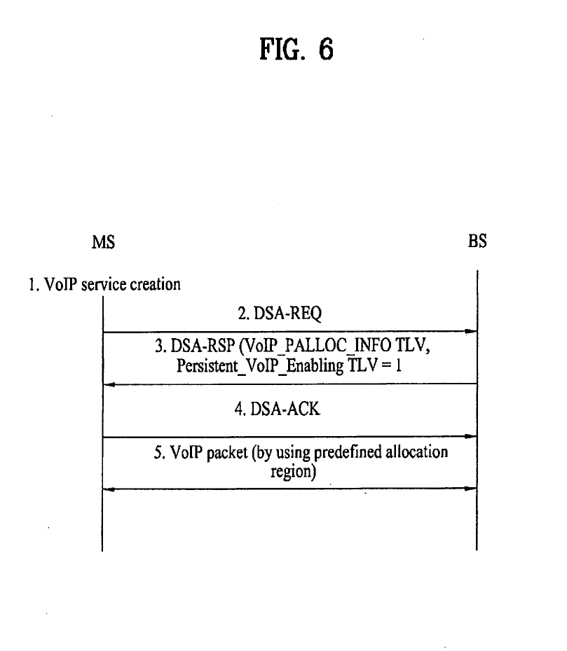

FIG. 6 illustrates an embodiment wherein a BS allocates resources for VoIP to a terminal in advance using service creation messages (DSA-REQ/RSP messages) in the case where the terminal has requested that a service be created.

In order to initialize a VoIP service (1), the terminal transmits a service creation request (DSA-REQ) message to the BS (2). Upon receiving the service creation request message, the BS transmits a service creation response (DSA-RSP) message including allocated region information (VoIP_PALLOC_INFO TLV) and persistent allocation enabling information (Persistent_VoIP_Enabling TLV) to the terminal as a response to the request (3). Upon receiving the response message, the terminal transmits a service creation acknowledgement (DSA-ACK) message to the BS (4) and stores persistent resource allocation information included in the response message (4). The terminal transmits and receives packets to and from the BS using the stored resource allocation information (5).

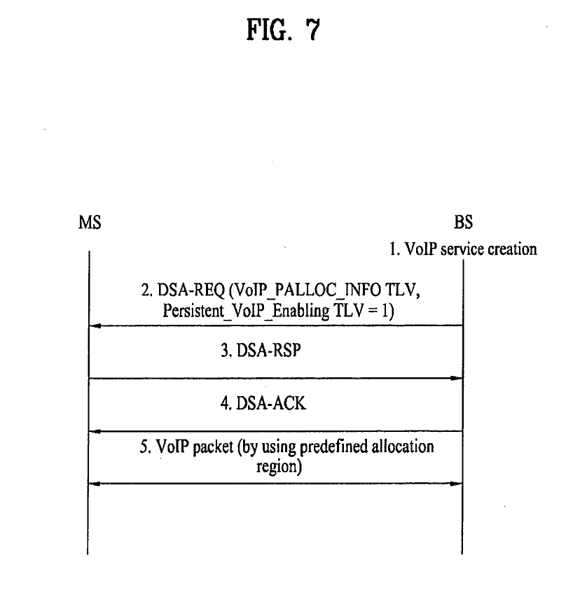

FIG. 7 illustrates another embodiment wherein a BS allocates resources for VoIP to a terminal in advance using service creation messages (DSA-REQ/RSP messages) in the case where the BS has requested that a service be created.

In order to initialize a VoIP service (1), the BS transmits a service creation request (DSA-REQ) message including allocated region information (VoIP_PALLOC_INFO TLV) and persistent allocation enabling information (Persistent_VoIP_Enabling TLV=1) to the terminal (2). Upon receiving the service creation request message, the terminal transmits a service creation response (DSA-RSP) message to the BS as a response to the request and stores resource allocation information included in the request message (3). Upon receiving the response message, the BS transmits a service creation acknowledgement (DSA-ACK) message to the terminal (4). The terminal transmits and receives packets to and from the BS using the stored resource allocation information (5).

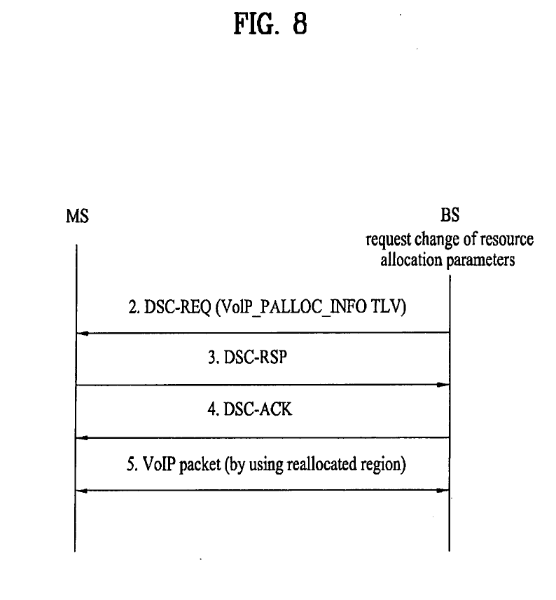

FIG. 8 illustrates another embodiment wherein a BS changes an allocated resource region using service creation messages (DSC-REQ/RSP messages).

In order to request that a resource region be changed (1), the BS transmits a service change request (DSC-REQ) message including changed resource allocated region information (VoIP_PALLOC_INFO TLV) to a corresponding terminal (2). Upon receiving the service change request message, the terminal transmits a service change response (DSC-RSP) message to the BS as a response to the request (3). Upon receiving the response message, the BS transmits a service change acknowledgement (DSC-ACK) message to the terminal (4). The terminal changes the resource region information received from the BS and transmits and receives packets to and from the BS using the changed resource region information (5).

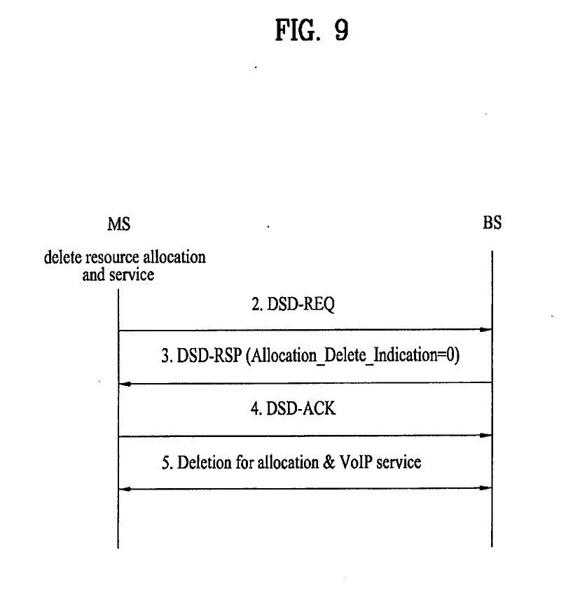

FIG. 9 illustrates an embodiment wherein a BS deletes a resource region allocated to a terminal using service creation messages (DSD-REQ/RSP messages) in the case where the terminal has requested that a service be deleted.

In order to remove a service (1), the terminal transmits a service deletion request (DSD-REQ) message to a corresponding BS (2). Upon receiving the service deletion request message, the BS transmits a service deletion response (DSD-RSP) message including resource allocation deletion indication information (Allocation_Delete_Indication TLV==0) to the terminal as a response to the request (3). After confirming that the Allocation_Delete_Indication has been set to “0”, the terminal determines that relevant service information and resource region information of the service should be deleted. Upon receiving the response message, the terminal transmits a service deletion acknowledgement (DSD-ACK) message to the BS (4). Then, the terminal and the BS remove both the relevant service information and the information of the resource region allocated to the service (5).

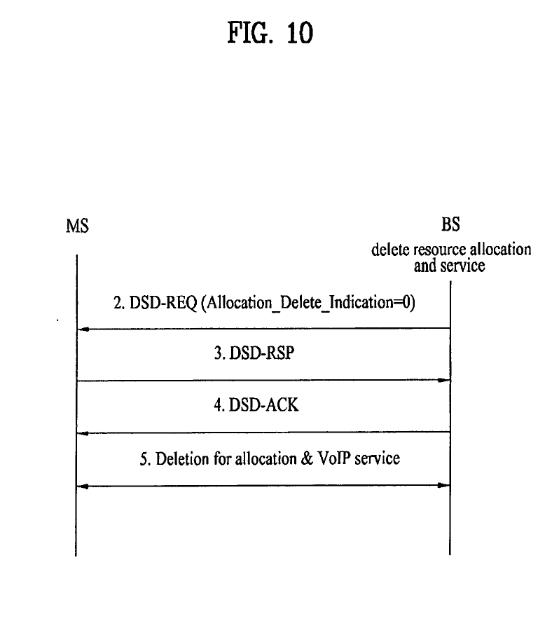

FIG. 10 illustrates another embodiment wherein a BS deletes a resource region allocated to a terminal using service creation messages (DSD-REQ/RSP messages) in the case where the BS has requested that a service be deleted.

In order to remove a service and an allocated resource region (1), the BS transmits a service deletion request (DSD-REQ) message including resource allocation deletion indication information (Allocation_Delete_Indication TLV==0) to a corresponding terminal (2). Upon receiving the service deletion request message, the terminal transmits a service deletion response (DSD-RSP) message to the BS as a response to the request (3). After confirming that the Allocation_Delete_Indication has been set to “0”, the BS determines that relevant service information and resource region information should be deleted. Upon receiving the response message, the BS transmits a service deletion acknowledgement (DSD-ACK) message to the terminal (4). Then, the BS and the terminal remove both the relevant service information and the information of the resource region allocated to the service (5).

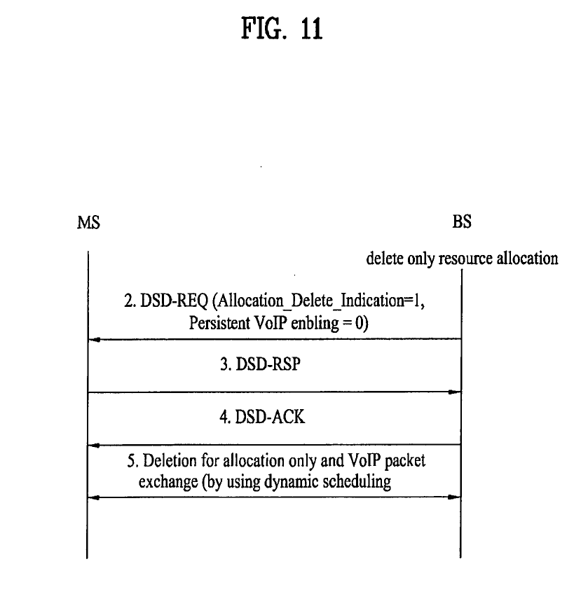

FIG. 11 illustrates another embodiment wherein a BS deletes a resource region allocated to a terminal using service creation messages (DSD-REQ/RSP messages) in the case where only the allocated resource region is deleted.

In order to remove only the allocated resource region (1), the BS transmits a service deletion request (DSD-REQ) message including resource allocation deletion indication information (Allocation_Delete_Indication TLV==1) to a corresponding terminal (2). Upon receiving the service deletion request message, the terminal transmits a service deletion response (DSD-RSP) message to the BS as a response to the request (3). After confirming that the Allocation_Delete_Indication has been set to “1”, the BS determines that only the resource region information should be deleted. Upon receiving the response message, the BS transmits a service deletion acknowledgement (DSD-ACK) message to the terminal (4). Then, the BS and the terminal remove the information of the resource region allocated to the relevant service. Then, the BS allocates resources to the terminal using a dynamic scheduling method and the terminal transmits and receives packets to and from the BS using the allocated resources (5).

In the example described above, information of resource allocation/change/deletion for VoIP is exchanged using service addition/change/deletion (DSA/DSC/DSD) messages among MAC management messages. However, in another example of the present invention, MAC management messages other than the service addition/change/deletion messages or newly defined MAC management messages can also be used for resource allocation/change/deletion for VoIP.

The following Tables 13 to 18 illustrate MAC management messages that are suggested for persistent resource allocation, change, and deletion in the present invention. The resource allocation information defined in the above Tables 9 and 10 can be included in a TLV form in each MAC management message.

Table 13 represents a resource allocation request (Resource_Alloc-REQ) that is a MAC management message that the present invention suggests for allocating resources for a service.

TABLE 13

| Syntax | Size | Notes |
|---|---|---|
| Resource_Alloc-REQ_Message_Format( ) { | | |
| Management Message Type = x | 8 bits | |
| TLV Encoded Information | Variable | TLV-specific |
| } | | |

Table 14 represents a resource allocation response (Resource_Alloc-RSP) that is a MAC management message that the present invention suggests for allocating resources for a service.

TABLE 14

| Syntax | Size | Notes |
|---|---|---|
| Resource_Alloce-RSP_Message_Format( ) { | | |
| Management Message Type = x | 8 bits | |
| TLV Encoded Information | Variable | TLV-specific |
| } | | |

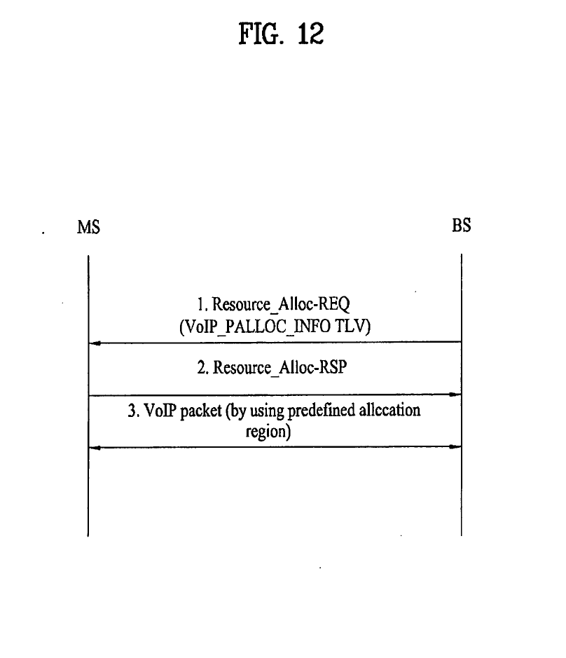

FIG. 12 illustrates an embodiment wherein resources for VoIP are allocated in advance using a MAC management message suggested in the present invention.

When a BS desires to allocate resources, the BS transmits a resource allocation request message (Resource_Alloc-REQ) to a corresponding terminal (1). Upon receiving the request message, the terminal transmits a resource allocation response message (Resource_Alloc-RSP) to the BS (2) and transmits and receives packets to and from the BS based on information included in the request message (3).

Table 15 represents a resource change request (Resource_Change-REQ) that is a MAC management message that the present invention suggests for changing allocated resources for a service.

TABLE 15

| Syntax | Size | Notes |
|---|---|---|
| Resource_Change-REQ_Message_Format( ) { | | |
| Management Message Type = x | 8 bits | |
| TLV Encoded Information | Variable | TLV- |
| | | specific |
| } | | |

In addition, Table 16 represents a resource change response (Resource_Change-RSP) that is a MAC management message that the present invention suggests for changing resources for a service.

TABLE 16

| Syntax | Size | Notes |
|---|---|---|
| Resource_Change-RSP_Message_Format( ) { | | |
| Management Message Type = x | 8 bits | |
| TLV Encoded Information | Variable | TLV-specific |
| } | | |

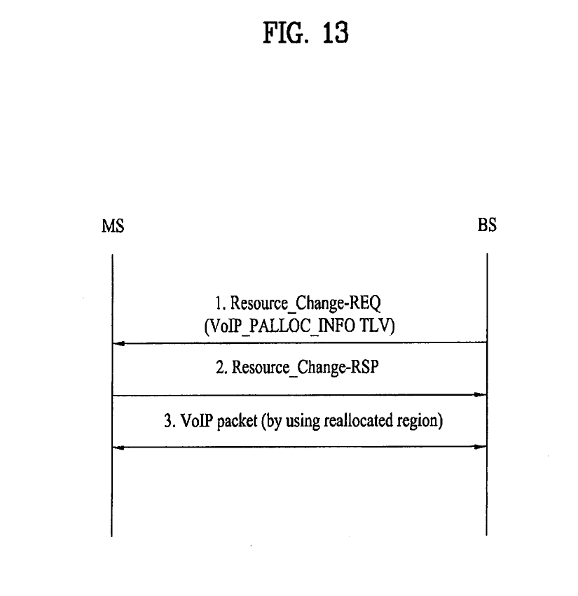

FIG. 13 illustrates an embodiment wherein allocated resources are changed using a MAC management message suggested in the present invention.

When a BS desires to change allocated resources, the BS transmits a resource change request message (Resource_Change-REQ) to a corresponding terminal (1). Upon receiving the request message, the terminal transmits a resource change response message (Resource_Change-RSP) to the BS (2) and transmits and receives packets to and from the BS based on the changed information (3).

The following Table 17 represents a resource deletion request (Resource_Delete-REQ) that is a MAC management message that the present invention suggests for deleting allocated resources for a service.

TABLE 17

| Syntax | Size | Notes |
|---|---|---|
| Resource_Delete-REQ_Message_Format( ) { | | |
| Management Message Type = x | 8 bits | |
| TLV Encoded Information | Variable | TLV-specific |
| } | | |

In addition, Table 18 represents a resource deletion response (Resource_Delete-RSP) that is a MAC management message that the present invention suggests for deleting resources for a service.

TABLE 18

| Syntax | Size | Notes |
|---|---|---|
| Resource_Delete-RSP_Message_Format( ) { | | |
| Management Message Type = x | 8 bits | |
| TLV Encoded Information | Variable | TLV-specific |
| } | | |

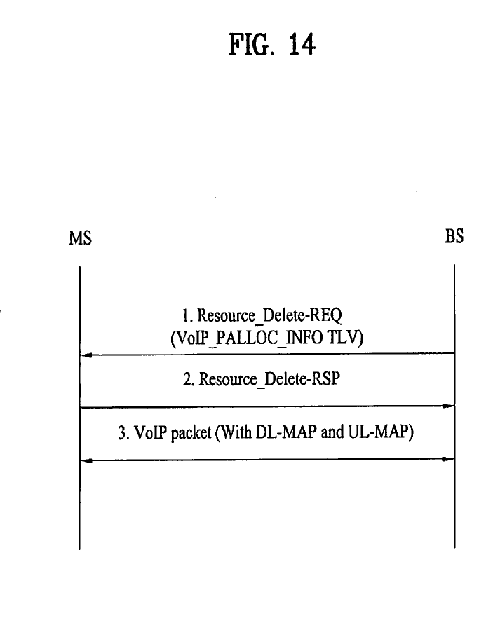

FIG. 14 illustrates an embodiment wherein allocated resources are deleted using a MAC management message suggested in the present invention.

When a BS desires to delete allocated resources, the BS transmits a resource deletion request message (Resource_Delete-REQ) to a corresponding terminal (1). Upon receiving the request message, the terminal transmits a resource deletion response message (Resource_Delete-RSP) to the BS and deletes relevant information (2). In subsequent periods, the BS allocates resources to the terminal using dynamic scheduling (for example, using a MAP IE) and transmits and receives packets to and from the terminal using the resources allocated through the MAP (3).

The detailed description of the preferred embodiments of the present invention has been given to enable those skilled in the art to implement and practice the invention. Although the invention has been described with reference to the preferred embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

According to the embodiments of the present invention described above, it is possible to reduce both MAP overhead for notification of a resource allocated region of VoIP traffic and processing overhead of terminals.

1. A method for transmitting signals, the method comprising:
reading first uplink MAP information including resource allocation information and transmission period information, and
performing first transmission through an allocated resource region according to the resource allocation information; and performing second transmission once or more through the allocated resource region of the first transmission in periods according to the transmission period information,
wherein the resource allocation information includes start position information of the allocated resource region.

2. The method according to claim 1, wherein a signal transmitted in the first and second transmission is a Voice-over-Internet-Protocol (VoIP) signal.

3. A method for transmitting signals, the method comprising:
reading first uplink MAP information including resource allocation information and transmission period
information, and performing first transmission through an allocated resource region according to the resource allocation information; and
performing second transmission once or more through the allocated resource region of the first transmission in periods according to the transmission period information,
wherein the first uplink MAP information includes position information of a resource region for Voice-over-Internet-Protocol (VoIP) signal transmission.

4. The method according to claim 1, further comprising:
stopping the second transmission, when a second uplink MAP including information different from at least one of the resource allocation information and the transmission period information of the first uplink MAP is received, and performing third transmission according to the information of the second uplink MAP.

5. The method according to claim 1, further comprising:
stopping the second transmission when a third uplink MAP for allocating the allocated resource region of the first transmission to different signal transmission is received in a period according to the transmission period information.

6. The method according to claim 2, wherein the first uplink MAP includes separate resource allocation information for the VoIP signal transmission.

7. The method according to claim 2, further comprising:
reading the first uplink MAP to determine information which the first uplink MAP includes from among initial allocation information of uplink resources for the VoIP signal transmission, parameter change information for uplink resource allocation for the VoIP signal transmission, and deallocation information of uplink resources that have been previously allocated for the VoIP signal transmission.

8. A method for allocating resources, the method comprising:
allocating a predetermined resource region for first transmission of a terminal and transmitting uplink MAP information including transmission period information and allocation information of the resource region; and
allocating the resource region, which was allocated for the first transmission in periods according to the transmission period information, for performing second transmission of the terminal once or more,
wherein the allocation information of the resource region includes start position information of the resource region.

9. A method for allocating resources, the method comprising:
allocating a predetermined resource region for first transmission of a terminal and transmitting uplink MAP information including transmission period information and allocation information of the resource region; and
allocating the resource region, which was allocated for the first transmission in periods according to the transmission period information, for performing second transmission of the terminal once or more,
wherein the uplink MAP information further includes position information of a resource region that has been previously allocated for Voice-over-Internet-Protocol (VoIP)) signal transmission.

10. A method for transmitting signals, the method comprising:
reading first control information including resource allocation information and transmission period information and performing first transmission through an allocated resource region according to the resource allocation information; and
performing second transmission once or more through the allocated resource region of the first transmission in periods according to the transmission period information, wherein the resource allocation information includes start position information of the allocated resource region.

11. The method according to claim 10, further comprising:
stopping the second transmission, when second control information including information different from at least one of the resource allocation information and the transmission period information of the first control information is received, and performing third transmission according to the information of the second control information.

12. The method according to claim 11, wherein the first control information and the second control information are transmitted through an uplink MAP or a MAC management message.

13. The method according to claim 12, wherein, when the first control information and the second control information are transmitted through the MAC management message, the first control information and the second control information are transmitted through a service creation (DSA) message, a service change (DSC) message, a service deletion (DSD) message, or a newly defined MAC management message among MAC management messages according to control information included in each of the first control information and the second control information.

14. The method according to claim 2, further comprising:
stopping the second transmission, when a second uplink MAP including information different from at least one of the resource allocation information and the transmission period information of the first uplink MAP is received, and performing third transmission according to the information of the second uplink MAP.

15. The method according to claim 3, further comprising:
stopping the second transmission, when a second uplink MAP including information different from at least one of the resource allocation information and the transmission period information of the first uplink MAP is received, and performing third transmission according to the information of the second uplink MAP.

16. The method according to claim 2, further comprising:
stopping the second transmission when a third uplink MAP for allocating the allocated resource region of the first transmission to different signal transmission is received in a period according to the transmission period information.

17. The method according to claim 3, further comprising:
stopping the second transmission when a third uplink MAP for allocating the allocated resource region of the first transmission to different signal transmission is received in a period according to the transmission period information.

18. The method according to claim 6, further comprising:
reading the first uplink MAP to determine information which the first uplink MAP includes from among initial allocation information of uplink resources for the VoIP signal transmission, parameter change information for uplink resource allocation for the VoIP signal transmission, and deallocation information of uplink resources that have been previously allocated for the VoIP signal transmission.
